(19) United States
(12) Patent Application Publication
(10) Pub. No.: US 2012/0185477 A1
(43) Pub. Date: Jul. 19, 2012

(54) System and method for supplying missing impact factors in a database

(76) Inventors: Amip J. Shah, Santa Clara, CA (US); Manish Marwah, Palo Alto, CA (US)

(21) Appl. No.: 13/007,073

(22) Filed: Jan. 14, 2011

(51) Int. Cl. G06F 17/30

(52) U.S. Cl. 707/737; 707/E17.089

(57) ABSTRACT

Systems and methods of supplying missing impact factors in a database. An example of a method is carried out by program code stored on non-transient computer-readable medium and executed by a processor. The method includes providing a matrix of each tree in the database in computer-readable medium, with each dimension in the matrix representing a node of the tree, and each of another dimension in the matrix representing an impact factor for a component of a system under consideration. The method also includes identifying at least one missing impact factor in the matrix. The method also includes estimating the missing impact factor and populating the estimated impact factor in the matrix in the computer-readable medium.

### CROSS-REFERENCE TO RELATED APPLICATIONS

This patent application is related to U.S. patent applications identified by the following docket numbers: 20106031, 20106054, 201006030, 700205164, 700205165, 700205166, 700205458 each filed the same day as this patent application, and each incorporated by reference for the disclosed subject matter as though fully set forth herein.

### BACKGROUND

Manufacturers in various industries use proprietary databases to track the price of individual components used during manufacturing, to determine how the change in price of various components impacts the overall price for their products. For example, a packaging manufacturer may maintain a database including price to obtain the stock materials (e.g., cardboard, plastic, and ink), produce the packaging (e.g., including cutting the cardboard, extruding the plastic, and printing the labels), and delivering the packaging to their customers. When the price of a component changes (e.g., fuel prices rise, thereby raising the price to obtain the stock materials and delivery), the manufacturer is able to use their database to quickly determine the overall impact the component change in price has on the overall price of their product so that the manufacturer can raise the price of their product (or make other adjustments) in a timely manner to reduce or eliminate any impact on their profit.

Manufacturers can also consider the impact of their products on the environment and other parameters. Electronics devices (e.g., computers, printers, and mobile phones), can be a concern because these devices typically have very short lifetimes and are commonly discarded by consumers when newer devices become available. For example, users may discard their mobile phone every two years when they are offered free or discounted equipment to renew their mobile phone contract with their carrier. Consumers also may discard their computers, televisions, and other appliances after only a few years of service, often because it is less expensive to replace than to repair.

Life Cycle Analysis (LCA) databases are beginning to become publicly available. For example, the Open LCA initiative is a public domain data sharing protocol. These databases may include, for example, data related to the mining efforts of raw materials, in addition to the disposal/recycling efforts to handle the components of products after consumers discard the products. These databases have thus far experienced limited adoption.

The databases include vast amounts of data that can be useful to manufacturers given the component breakdown of current products. It is said, for example, that a product as simple as a pen can include over 1500 parameters when considered on a cradle-to-grave basis.

Even a fairly comprehensive databases may be missing some data (e.g., for new product components or for components that are expensive or difficult to determine data for) and/or may include invalid data (e.g., improperly entered or outdated data). Accordingly, analysis that relies on this missing or invalid data is incomplete, leaving the user to guess what the complete analysis might be, or altogether ignore the output of any such analysis.

### BRIEF DESCRIPTION OF THE DRAWINGS

FIG. 1A is a high-level block-diagram of an example computer system that can supply missing impact factors in a database.

FIG. 1B shows an example architecture of machine readable instructions for database program code that may be executed to supply missing impact factors in a database.

FIG. 2A illustrates an example structure for a multidimensional data structure.

FIG. 2B illustrates a plurality of tree structures that may be provided in the data structure.

FIG. 2C shows an example of a new system tree.

FIGS. 3A and 3B illustrate an example of supplying missing impact factors in a database.

FIG. 4 is a flowchart illustrating example operations of supplying missing impact factors in a database.

FIG. 5 is a flowchart illustrating example operations of component substitution which may be implemented.

### DETAILED DESCRIPTION

A user may use conventional databases to determine whether a component in a product might have a higher price or a bigger impact than another component. But manufacturing decisions can be more complex than this. Manufacturers may take into consideration a wide variety of characteristics of many different components. Other factors that may also be considered include the intended use of the product, availability of components, customer demand, regulations and laws, to name only a few examples.

As used herein, the term “includes” means includes but not limited to, the term “including” means including but not limited to. The term “based on” means based at least in part on.

Simply substituting a plastic component for a metal component in a product because it has a lower environmental impact may not be possible based on one or more other consideration. For example, a certain type of plastic may indeed have a lower environmental impact, but lacks durability (affecting customer satisfaction and/or warranty). Therefore, the plastic may not be a suitable substitution for the metal component. In another example, the plastic may be more expensive than the metal, or fail on some other parameter. Decisions to substitute components cannot be made by simply consulting a database, without some analysis of many different information paths. But the databases used for these analysis may be incomplete (e.g., including missing and/or incorrect information).

Briefly, systems and methods are provide herein that facilitate supplying missing impact factors in a database for large-scale data analysis, thereby enabling informed design decisions. In an example, a system and method described herein can be used to automatically supply missing impact factors in the database. It is noted that although the systems and methods are described herein with reference to the design and manufacture of a system under consideration, the systems and methods can broadly be applied to the design and implementation of any of a wide range of different types of devices and/or services (generally referred to herein as the “system under consideration”).

An example of a system includes a computer readable storage to store at least one system tree having a plurality of nodes. The system tree may be stored in a data structure (e.g., a database). Each node in the system tree represents a characteristic of a component of system under consideration. For example, a system tree for a new computer may include a keyboard node, a motherboard node, a hard disk drive node, a display node, and so forth. Each node may also include child nodes. For example, the motherboard node may also include child nodes for motherboard components, such as the onboard memory, processor, and so forth. The database may include information about price of the product, environmental impact, performance, product warranty, customer satisfaction, among others, for each of the nodes in the tree. The information may be referred to generally as “cost.” That is, the term “cost” may include price, carbon footprint, energy consumption (e.g., kilowatt hours), number of warranty calls and/or price associated with those warranty calls, and any other suitable metric for characterizing different components of a system under consideration.

Information for the node(s) may be incomplete or altogether missing. For example, the information may have been input incorrectly, drawn from a wrong or unreliable source, outdated, or simply unavailable (e.g., for a new product component). Each of these types of insufficient information are referred to generally herein as “missing” values. Several techniques are described in more detail below, which may be used to determine the missing impact factors. These techniques may be used individually or in combination with one another. In each of these techniques, the database is treated as a matrix with each dimension (e.g., row) representing a node and each of another dimension (e.g., column) representing an impact factor. The techniques include clustering based on impact factors, k-nearest neighbor, and node similarity. Of course these techniques are merely representative, and other techniques may also be used, as will be readily appreciated by those having ordinary skill in the art after becoming familiar with the teachings herein.

After completing the missing entries in the database, an analysis engine may be operatively associated with the computer readable storage to compare nodes of the system tree with nodes in other trees, and make substitutions based on the analysis. For example, the analysis engine may compare nodes of the system tree for the new computer with other trees for other computers. The analysis engine may determine that the other trees for a laptop computer, desktop computer, and netbook computer, all have the same motherboard node, and that the motherboard node of a laptop computer makes a suitable substitution for a new desktop computer product.

The systems and methods described herein provide for supplying missing impact factors in a database. The impact supplied factors may be used for component substitution for device manufacture. Component substitution may be based on a knowledge base of information for existing components, without the need to develop new components, to meet or exceed customer expectations, marketing goals, environmental impact, and/or other considerations.

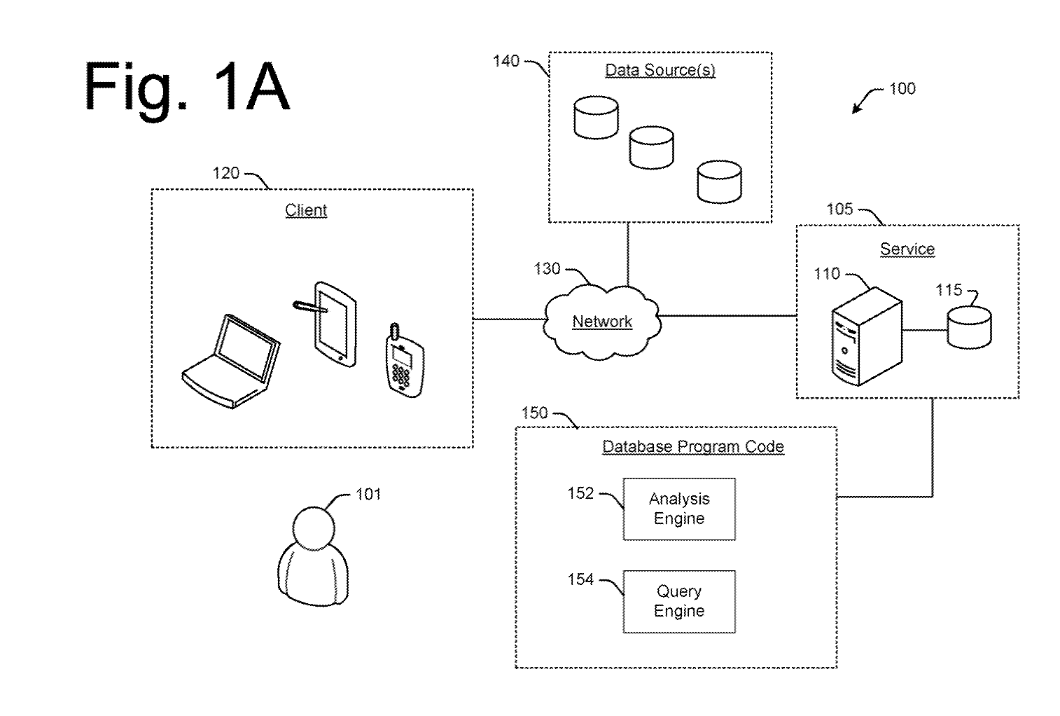

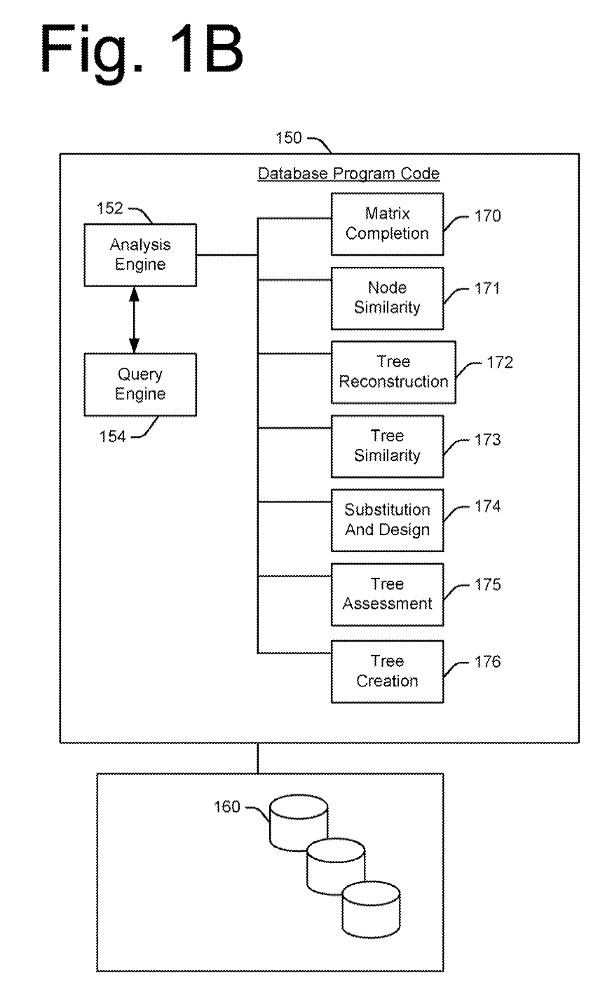

FIG. 1A is a high-level block-diagram of an example computer system 100 that may be implemented to supply missing impact factors in a database. System 100 may be implemented with any of a wide variety of computing devices, such as, but not limited to, stand-alone desktop/laptop/netbook computers, workstations, server computers, blade servers, mobile devices, and appliances (e.g., devices dedicated to providing a service), to name only a few examples. Each of the computing devices may include memory, storage, and a degree of data processing capability at least sufficient to manage a communications connection either directly with one another or indirectly (e.g., via a network). At least one of the computing devices is also configured with sufficient processing capability to execute the program code described herein.

In an example, the system 100 may include a host 110 providing a service 105 accessed by a user 101 via a client device 120. For purposes of illustration, the service 105 may be a data processing service executing on a host 110 configured as a server computer with computer-readable storage 112. The client 120 may be any suitable computer or computing device (e.g., a mobile device) capable of accessing the host 110. Host 110 and client 120 are not limited to any particular type of devices. It is also possible for the host 110 and client 120 to be the same device (e.g., a kiosk platform). Although, it is noted that the database operations described herein which may be executed by the host 110 are typically better performed on a separate computer system having more processing capability, such as a server computer or plurality of server computers. The user interface may be provided on any computing device for providing data to, and receiving data from, service 105.

The system 100 may also include a communication network 130, such as a local area network (LAN) and/or wide area network (WAN). In one example, the network 130 includes the Internet or other mobile communications network (e.g., a 3G or 4G mobile device network). Network 130 provides greater accessibility to the service 105 for use in distributed environments, for example, where more than one user may have input and/or receive output from the service 105.

In an example, the host 110 is implemented with (or as part of) the service 105 in the networked computer system 100. For example, the service 105 may be a cloud-based service, wherein the host 110 is at least one server computer in a cloud computing system. The host 110 may be provided on the network 130 via a communication connection, such as via an Internet service provider (ISP). In this regard, the client 120 is able to access host 110 directly via the network 130, or via an agent, such as a network site. In an example, the agent may include a web portal on a third-party venue (e.g., a commercial Internet site), which facilitates a connection for one or more clients 120 with host 110. In another example, portal icons may be provided (e.g., on third-party venues, pre-installed on a computer or mobile device, etc.) to facilitate a communications connection between the host 110 and client 120.

Before continuing, it is noted that the host 110 is not limited in function. The host 110 may also provide other services to other computing or data processing systems or devices in the system 100. For example, host 110 may also provide transaction processing services, email services, etc.

In addition, the host 110 may be operable to communicate with at least one information source 140. The source 140 may be part of the service 105, and/or the source 140 may be distributed in the network 130. The source 140 may include any suitable source(s) for information about various components of systems. For example, the source 140 may include manufacturer specifications, proprietary databases, public databases, and/or a combination of these, to name only a few examples of suitable sources. The source 140 may include automatically generated and/or manual user input. If the source 140 includes user-generated data, an appropriate filter may be applied, e.g., to discard “bad” data or misinformation. There is no limit to the type or amount of information that may be provided by the source 140. In addition, the information may include unprocessed or “raw” data. Or the data may undergo at least some level of processing.

The host 110 may execute analytics using the information from the source 140 to generate output for use in component substitution for device manufacture. For example, the host 110 receives information from the source 140 including environmental impact based on a cradle-to-grave assessment for various components that may be used in a system under consideration. The host 110 may maintain the results in at least one data structure (e.g., a matrix or table or database) in computer-readable media 115. The data structure may be accessed by the host 110, which performs analytics based on input by the client 120, and outputs the results for the user at the client 110.

In an example, the host 110 performs the analytics described herein by executing database program code 150. The database program code 150 may include an analysis engine 152 and a query engine 154. In an example, the analytics engine 152 may be integrated into the query engine 154. The analytics engine 152 may be an SQL-based analytics engine, and the query engine 154 may be an SQL query engine. However, the operations described herein are not limited to any specific implementation with any particular type of database.

A system that implements component substitution for device manufacture as described herein has the capability to take a description of a system under consideration (e.g., in terms of inherent properties of the device), and assess the characteristics (e.g., price, environmental footprint, customer satisfaction, warranty) of the individual components comprising the system under consideration. The system may then output a list of substitute components and/or an assessment of various product designs. Component substitution may be better understood with reference to the following discussion of an example implementation of machine readable instructions.

FIG. 1B shows an example architecture of machine readable instructions for the database program code 150 that may be executed to supply missing impact factors in a database. In an example, the database program code 150 may be implemented in machine-readable instructions (such as but not limited to, software or firmware) stored on a computer readable medium (e.g., storage 115 in FIG. 1A) and executable by one or more processor (e.g., on host 110 in FIG. 1A) to perform the operations described herein. The database program code 150 may perform operations on at least one database 160 (or other data structure). The database 160 may be provided on the same or different computer readable medium (e.g., storage 115 in FIG. 1A). It is noted, however, the components shown in FIGS. 1A and 1B are provided only for purposes of illustration of an example operating environment, and are not intended to limit execution to any particular system.

During operation, the analysis engine 152 may be operatively associated with the query engine 154 to execute the function of the architecture of machine readable instructions as self-contained modules. These modules can be integrated within a self-standing tool, or may be implemented as agents that run on top of an existing database. Existing data are used as seed data to populate a matrix. A comparison is then run between the device and the populated matrix using node comparison techniques (and related algorithms). After a set of similar nodes has been identified, trees are constructed to identify the structure resident within the similar nodes. The constructed tree is then compared to the system tree. When a similar tree (or set of trees) has been identified, the tree(s) are assessed for one or more parameter (e.g., environmental footprint). In an example, one or more node (e.g., portions of trees or even entire trees) may be substituted in the system tree. For example, the offending node(s) may be replaced with potentially better rated nodes, and also assessed to identify a better rated tree. The highly-rated tree(s) are used to mine the populated matrix for novel sub-trees from other devices, which may lead to a better rated solution for manufacturing the new system under consideration.

In an example, the architecture of machine readable instructions may include a matrix completion module 170. The matrix completion module 170 may populate the database with information related to various devices. The information may include price and environmental impact, among other characteristics. Existing data from commercial databases, published literature, or internal systems may be used as seed data. The seed data is then expanded through one or more of data mining, knowledge discovery, regression, and/or other techniques. In this manner, only a few starting points of readily available data are used initially, and more comprehensive information can be constructed for the database.

The architecture of machine readable instructions may also include a node similarity module 171. The node similarity module 171 may be used to identify relevant characteristics of the device being assessed. These characteristics may be relevant to at least one of the parameters. For example, the published energy use rate for the device is directly related to environmental impact. But the characteristics may also include part name, part number, composition of the device, etc. The relevant characteristics of the device are then compared to the matrix of information in the database to identify any similar nodes. These nodes may be considered to be similar at the root (e.g., two different laptop computers), or similar in terms of other relational characteristics (e.g., a computer housing and a printer housing).

The architecture of machine readable instructions may also include a tree reconstruction module 172. After a group of related nodes have been identified, the tree reconstruction module 172 further outlines how the identified nodes are structurally related to one another. In an example, a root node is detected or inputted, and then the remaining nodes are identified as children or non-children of the root node. Based on the identified children nodes, a hierarchical structure may be generated which is used to construct a tree.

The architecture of machine readable instructions may also include a tree similarity module 173. After constructing a tree of relevant nodes from the populated matrix, this tree is then compared to the system tree. The system tree may be assessed, and a bill-of-materials developed for the device. Examples of methods to identify metrics for comparing two trees, include but are not limited to, tree depth, breadth, and distance between relative nodes. The output may include a similarity rating relative to identified trees of relevance in the populated matrix.

The architecture of machine readable instructions may also include a tree substitution and design module 174. After two or more trees of relevance have been identified, opportunities to replace “offending” nodes in the system tree may be sought. For example, a laptop computer may be identified as being similar to another laptop computer stored in the database. Suppose the processors of each laptop computer are identified as the offender. Then, if the processor of another laptop computer tree has a lower environmental footprint than the processor in the system tree, the processor node in the other laptop tree may be substituted for the processor node in the system tree. The new system tree results in a laptop computer having a lower environmental footprint. Next, the tree substitution and design module moves on to the next highest offender (e.g., the hard disk drive node), and the process repeats. The output results in a new tree for the device having a lower environmental footprint.

The architecture of machine readable instructions may also include a tree assessment module 175. The tree assessment module 175 may be used to assess a device, rather than redesign the device. In an example, the total environmental footprint of the tree may be calculated based on the similarity metrics identified by the tree similarity module. Methods to rapidly calculate the footprint of very large trees based on a hierarchy of nodes with similar grouping may be utilized. The output of the tree assessment module may include an estimated environmental footprint of the system tree. Additional metrics of relevance may also be output. For example, additional metrics may include but are not limited to, the minimum calculated environmental footprint of substitutive trees, the most similar tree with a lower environmental footprint, and the average footprint of all relevant trees.

The architecture of machine readable instructions may also include a tree creation module 176. The tree creation module 176 utilizes output from the other modules (e.g., the tree reconstruction module 172 and the tree substitution module 174) to create new trees. The fundamental principle is that different systems may perform similar functions, but not necessarily be previously viewed in similar fashion. For example, a server computer may use a particular component hierarchy in the supply chain that is also relevant to a laptop computer. But the manufacturer may not have considered such a hierarchy for numerous reasons, not the least of which is the manufacturer's own belief that server computers are different than laptop computers.

It is noted that the functional modules are shown for purposes of illustration. Still other functional modules may also be provided. In addition, the functional modules may be combined with one another.

As noted above, the database 160 may store at least one tree with a plurality of nodes. Each node in the tree represents at least one characteristic of a device. For example, the database 160 may include a tree for a new computer. The new computer tree may include nodes for the motherboard, the hard disk drive, the keyboard, and the display. The motherboard node may include information about cost, e.g., at least one of price, environmental impact, performance, product warranty, and customer satisfaction, among other characteristics of the motherboard.

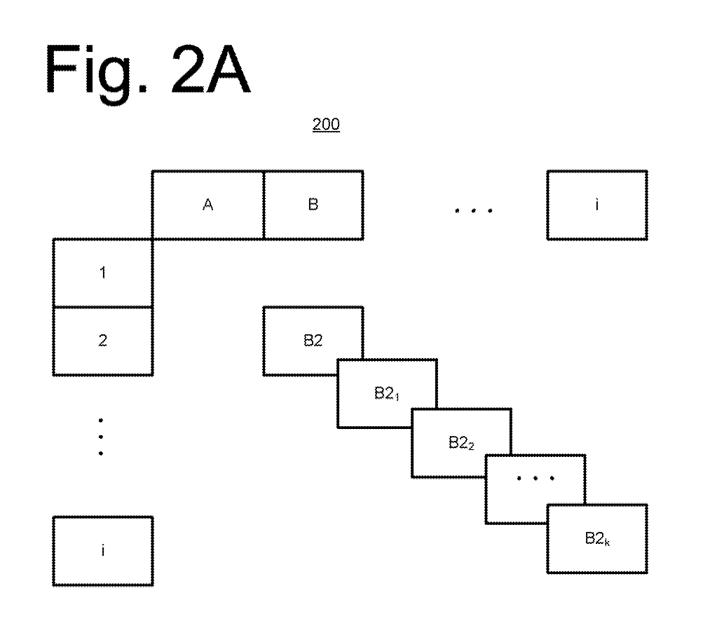

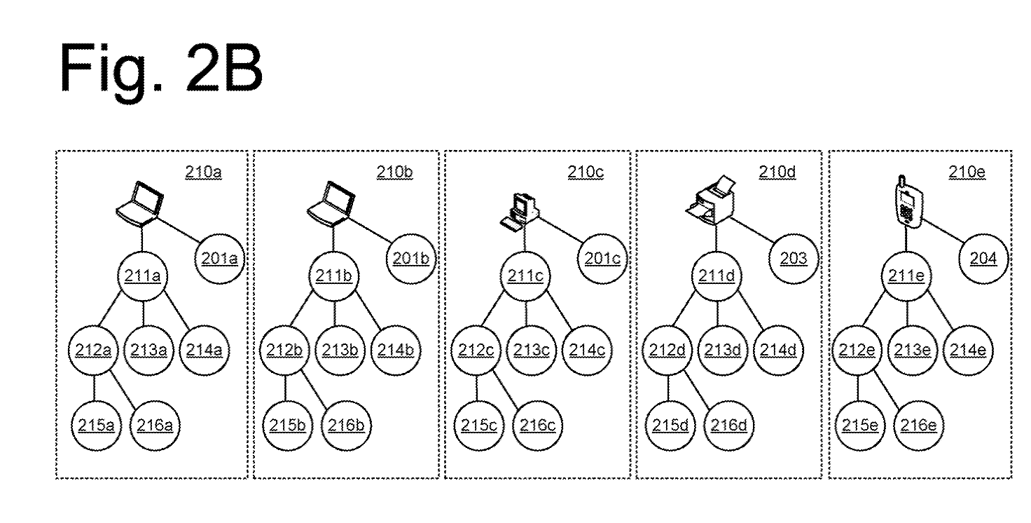

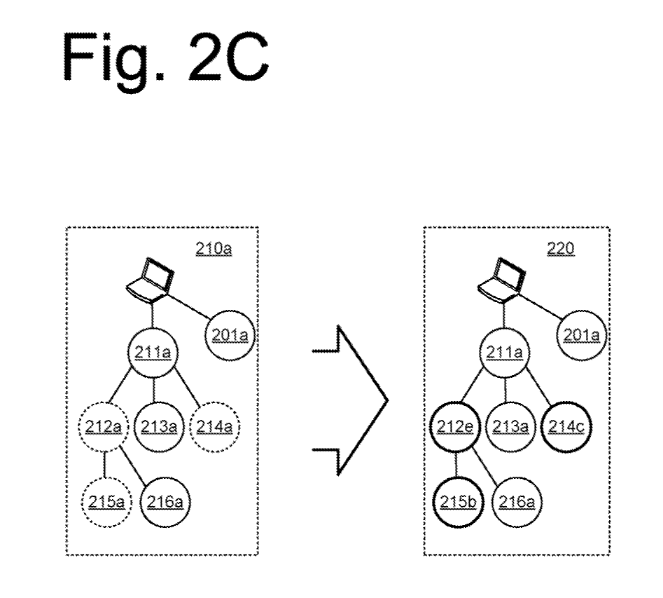

In an example, the database 160 may be a multidimensional data structure. FIG. 2A illustrates an example structure for a multidimensional data structure. In this example, the database is configured as a matrix 200 with information for each node. Example information may include, but are not limited to the following characteristics: price, environmental impact, performance, product warranty, and customer satisfaction, to name only a few examples.

In FIG. 2A, the matrix 200 includes a plurality of columns (A, B, . . . i) and a plurality of rows (1, 2, . . . j). The intersection of each dimension (e.g., row and column) may be referenced by the combination of row label and column label. For example, the intersection of column B and row 2 may be referred to as B2. In an example, each row corresponds to a component of a system under consideration, and is thus used to generate the nodes in trees. The columns correspond to characteristics for the components. In an example where column B is for a computer display and row 2 is for environmental impact, the intersection B2 may include environmental impact information (e.g., overall carbon footprint) for the computer display.

The matrix 200 is not limited to the two-dimensional example given above. In another example, the program code may go to the intersection B2, and then read forward/backward in a third dimension to obtain more detailed environmental impact information included in the overall carbon footprint calculation, such as but not limited to, energy use, toxic emissions, and waste disposal. For purposes of illustration, the addresses in the third dimension may be referenced using any suitable symbols, such as subscripts, wherein the address is B2₁, B2₂, . . . B2ₖ.

The information in the multidimensional data structure may be included in, or referenced by the nodes in the trees. For example, a printed circuit board node may reference intersection B2 in the matrix 200 for environmental impact information related to that particular printed circuit board. It is noted that multiple nodes in different trees may reference the same address in the same matrix 200. By way of illustration, the printed circuit board nodes in a plurality of different computer trees may each reference the intersection B2 in the same matrix 200, if intersection B2 includes information for environmental impact that is the same for each printed circuit board.

The matrix 200 shown in FIG. 2A is shown and described herein as an example of an example of a data structure that may be used. It is noted, however, that the tree structures may be based on information provided in any suitable format(s).

The tree structure provided in the database may be better understood from the following discussion with reference to FIG. 2B. FIG. 2B illustrates a plurality of tree structures 210a-e that may be provided in the database. The trees 210a-e each have a plurality of nodes. Each node in the tree 210a-e may further include subnodes, thereby defining a child-parent relationship between the nodes, and providing additional layers of granularity for the components of the system under consideration.

For purposes of illustration, the tree structures 210a-c are for computer devices. It is noted that any suitable number and type of other trees may be also used. For example, tree structure 210d is for a printer, and tree structure 210e is for a mobile phone. Accordingly, nodes that are suitable for substitution may be found in system trees that are not necessarily related to one another in a conventional sense. For example, a computer is different than a printer in most regards, which is different than a mobile phone. But there may be overlap in at least one of the nodes. For example, computers, printers, and mobile phones all have in common a processor, some degree of memory, and a housing.

In this example, all of the trees 210a-e (even the printer and mobile phone trees) include motherboard nodes 211a-e, in addition to nodes for other components. At least some of the other component nodes may be related in the different trees (e.g., nodes 201a-c are related). At least some of the other component nodes may not be related in the different trees (e.g., node 203 for ink cartridges in the printer tree 210d and node 204 for the antenna in the mobile phone tree 210e).

Continuing with this example, motherboard nodes 211a-c may include subnodes 212a-c for the circuit boards, subnodes 213a-c for the onboard memory, and subnodes 214a-c for the processors. These subnodes are each related to the respective motherboard nodes 211a-c as child nodes. Furthermore, the child nodes may also have child nodes of their own. For example, the circuit board nodes 212a-c may include child nodes 215a-c for the wafer and child nodes 216a-c for the metal traces.

During operation, program code (e.g., the database program code 150 in FIGS. 1A and 1B) is executed to create a system tree (e.g., system tree 210a in FIG. 2B) for a new system under consideration (e.g., a new laptop computer). The program code is also executed to identify and analyze other trees (e.g., system trees 210b-e). In an example, the program code traverses the trees and detects at least one root node in each of the trees. For example, the program code may compare nodes of the new system tree 210a with laptop/netbook computer trees 210b, desktop computer trees 210c, printer trees 210d, and mobile phone trees 210e. Each of the trees may include root nodes for motherboards (nodes 211a-e in FIG. 2B). Root nodes may also be identified for one or more subnode. Accordingly, the motherboard node 211a (and/or the subnodes) in the system tree 210a for the new system under consideration is compared to the motherboard nodes 211b-e in the other trees 210b-e.

The program may also be executed to rate the nodes. The nodes may be rated based on information in the database (e.g., in matrix 200 in FIG. 2A), to determine the suitability of a substitution. In an example, a higher rating may indicate a better candidate for substitution than a lower rating (although the opposite may also be true). For example, the motherboard node 211b of one of the laptop/netbook computer trees 210b may be assigned a higher rating for price than the motherboard node in the desktop computer trees 210c, because the price of the motherboard in the netbooks is lower than the price of the motherboard in the desktop computers. The motherboard node of the desktop computer trees 210c may be assigned a higher rating than the netbooks for performance. But the motherboard node 211b of the laptop/netbook computer trees 210b may receive higher ratings than the desktop computer trees 210c for environmental impact, because the processor in the laptop/netbook computers is more energy efficient.

The processor in one type of laptop computer may be more energy efficient than the processor in another laptop computer, and therefore the motherboard node for one of the laptop computer trees 210b may receive a higher rating than the motherboard node for the other laptop computers in the same group of trees 210b. The ratings may also be weighted. For example, environmental impact may receive a higher weighting if environmental impact is more pertinent to the user than price.

After a suitable substitution is determined, the program code may further be executed to create a new tree for the new system under consideration using node replacement or substitution based on nodes and/or subnodes in other trees. FIG. 2C shows an example of a new system tree 220. In this example, the new tree 220 is created from the tree 210a. But the new tree 220 is created with the node 215b from the laptop computer tree 210b because this node has the best rating for environmental impact. The new tree 220 is also created with the node 214c from the desktop computer trees, because this node has the best performance. The new tree 220 is also created with the node 212e from the mobile phone tree because this node has the lowest price.

It is readily appreciated from the above discussion that the systems and methods may be utilized to provide a quick assessment of a large amount of manufacturing information for a wide variety of different systems, and with high accuracy. The systems and methods may be used to modify device manufacture, including by reducing the price to manufacture, reducing the impact the device has on the environment, and reducing warranty calls, all while increasing customer satisfaction with the product. These considerations are particularly relevant for so-called “fleet” customers or enterprise customers who purchase in large quantities, and therefore carefully consider the many different impacts of their purchases.

In this regard, the systems and methods may be implemented as a product assessment service. For example, the systems and methods may be used by enterprises who demand emissions reduction or compliance with environmental goals and/or regulations. Many of these enterprises are turning to their vendors to help assess, monitor, and reduce their environmental footprint. The systems and methods not only enable manufacturers to competitively reduce the environmental footprint of their customers, but to also competitively reduce the environmental footprint of their own supply chain.

These considerations are also relevant to consumers who are becoming more conscious of the impact their own purchases have on the environment.

In addition to environmental impact, the systems and methods also provide the foundation for significant savings, both direct (e.g., supply-side) and indirect (e.g., reducing warranty calls). The ability to automate product analysis may be a differentiator for some manufacturers in reducing price for smaller customers, and scaling to meet the demands of larger customers, while maintaining or even growing profit margins.

Unfortunately, the databases used for these analysis may contain missing, incorrect, or incomplete information or values. This missing information makes it difficult to accurately analyze a particular node or entity of nodes. Obtaining the missing information may be difficult (e.g., for new components) or impossible (e.g., if the component manufacturer does not release certain information), and in some cases may at the very least be expensive. It is usually costly to evaluate all the impact factors related to a particular node. For example, commercial off-the-shelf databases may have upwards of 200 impact factors. For each of these impact factors, a user may have to manually evaluate the impact of the system in order to complete all nodes in the database.

Being able to estimate missing and/or invalid impact factors in the database allows analysis and results to be more accurate. It may be advantageous to intentionally not compute impact factor values for certain nodes to save costs, and then estimate those impact factors using the methods described below.

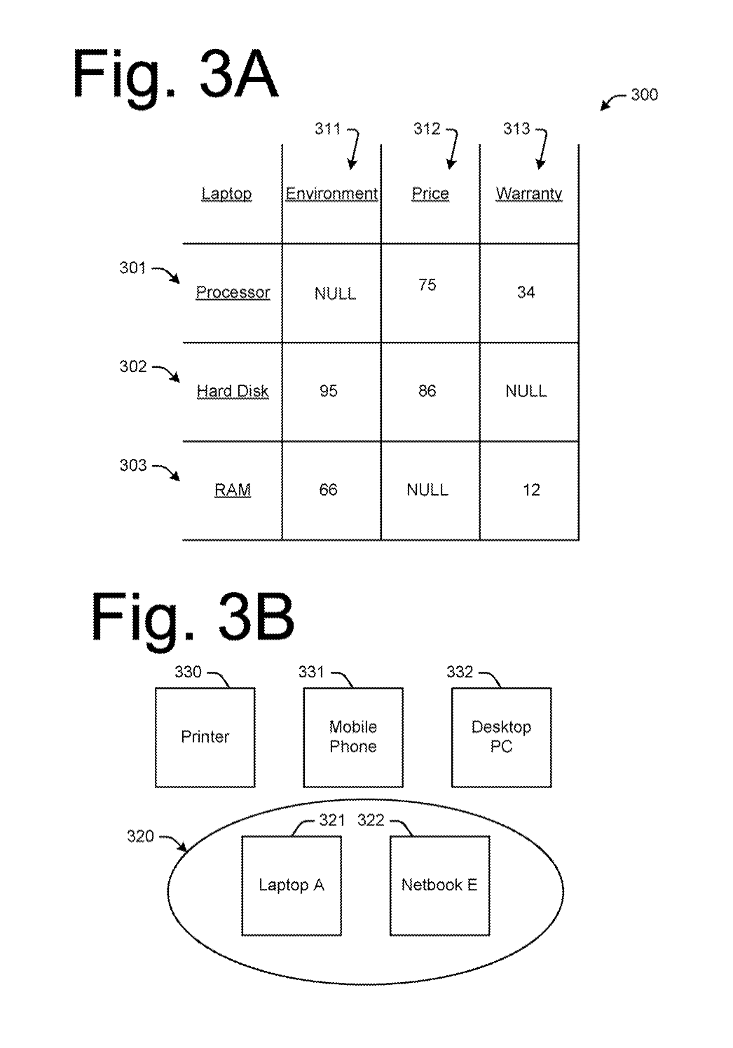

FIGS. 3A and 3B illustrate an example of supplying missing impact factors in a database. It is noted that in other examples, each column of the matrix is a different type of impact. In addition, each of the categories can span multiples columns and/or rows (generally referred to herein as “dimensions” in the database. Several techniques may be used to determine the missing impact factors in the database. These techniques may be used individually or in combination with one another. In each of the techniques described below, the database is treated as a matrix 300 with each row 301, 302, 303 representing a node, and each column 311, 312, 313 representing an impact factor. Of course the techniques described herein may also be used in a multi-dimensional database.

It can be seen in FIG. 3A that some impact factors are missing. Missing impact values are indicated by NULL in the illustration of FIG. 3A. For example, the environmental impact factor for the processor is missing or NULL, the price impact factor for the RAM is missing or NULL, and the warranty impact factor for the Warranty is missing or NULL.

In FIG. 3B, matrices for a laptop computer (Laptop A) and a netbook computer (Netbook E) are shown grouped 320 because these are the most similar matrices 321, 322, when compared to the matrices for the printer 330, the mobile phone 331, and the desktop PC 332. Of course this is a high-level illustration. Example techniques for grouping or clustering matrices are described in more detail below.

In a first example technique, nodes are clustered according to common impact factors (e.g., which may be represented mathematically as vectors). A multitude of clustering techniques, and associated algorithms, are available. For example, clustering algorithms may include statistical analysis such as, but not limited to, k-means, k-medians, agglomerative, and hierarchical methods.

In a second example technique, nodes are grouped based on a k-nearest neighbor approach. This approach is similar to clustering, but can be computationally more efficient. For the nodes with missing impact factors, the k nearest neighbors are determined based on the vector of all the impact factors. The missing impact factors are then determined from a statistic of the k neighbors.

In a third example technique, nodes are grouped based on a node similarity metric. This approach determines the node (or nodes) most similar to the one that has the missing impact factor(s). The missing impact factors are then determined from a statistic of the most similar node.

A combination of two or more of these or other techniques may also be used. Further, a number of criteria may be used to evaluate the cohesiveness of the clusters or groups to determine an appropriate number of clusters. Examples of such criteria include, but are not limited to, silhouette coefficients, ratio of within clusters sum of square distance to between clusters sum of square distances, information theoretic metrics (e.g., BIC, AIC, etc.). These techniques result in groups of nodes or entities of nodes with similar impact factor vectors.

The node with the missing impact factor(s) can then be fitted to one of the clusters or groups. A metric derived from that cluster or group can then be used to estimate the impact factor for the node. For example, the metric may be a statistical metric such as, but not limited to, mean, median, mode, etc.

In addition to the methods described above, the missing impact factors problem can be formulated as a matrix completion or collaborative filter problem, and any suitable techniques may be used to address the problem.

It should also be noted that one or more of the above techniques may be combined. As an illustration, if a laptop cluster exists within the database, and there is a new or existing node with missing data that corresponds to a laptop computer, then this node may be assigned to the existing cluster. Depending on how similar (or dissimilar) the new node is from those nodes in the existing cluster, the impact metrics can be automatically assigned. In one example, the node may be automatically assigned a generic value (such as, but not limited to mean, median, or mode). In another example, characteristics of the laptop are compared to existing nodes, and if an identical match exists, ,then the impact factors of the known node are copied exactly.

Augmentations to these techniques are also contemplated as being within the scope of the embodiments described herein. For example, the impact factors of the known node may be weighted during assignment. To illustrate, consider one unknown laptop and one known laptop. The term ‘unknown’ means that at least one of the impact factors for that laptop are not known. The term ‘known’ means that all of the impact factors for that laptop are known. In an example, let the known laptop be LK and the unknown be LU, with LK1, LK2, and so forth, representing the known impact factors, and LU1, LU2, and so forth, representing the unknown impact factors. In this example, the median impact factors of the laptop cluster are known (the median is represented as L), and the impact factors corresponding to the median are designated L1, L2, and so forth.

Three similarity (or distance) metrics can be assigned: (a) from the known to the median; (b) from the unknown to the median; and (c) from the known to the unknown. In an example, if these values are 0.5, 0.7, and 0.8 respectively, then the highest similarity becomes the driver for the assignment. In this example, the unknown (LU) is compared directly to the known (LK). But the impact factors are also weighted in proportion to the similarity. A similarity of ‘1’ means that the impact factors for LU are identical to LK.

This weighing may be based on a range of values considered in the comparison. In the example, the most dissimilar assignment to LU can be L1, L2, and so forth. This represents a similarity value of 0.5. On the other hand, the most similar assignment to LU is LK1, LK2, and so forth. This represents a similarity value of 0.8. By fitting a curve to the two matches, where an impact factor may be listed on the x-axis and the similarity metric is listed on the y-axis, and extrapolating to a point where the x-axis corresponds to 1, it is possible to project a new set of impact values for LU. If more nodes are available beyond LU and L, and a monotonic trend is seen, a better fit may be achieved.

The unknown impact factors may be a weighted sum of the other nodes in the cluster. The weights may be based on the similarity metric between the node with missing impact factors, and the other nodes in the duster. For example, the missing impact factor Fij can be estimated according to the following equation:

Fᵢⱼ=(ΣSᵢₖ*Fₖⱼ)/ΣSᵢₖ

where:
Fᵢⱼ is the jth impact factor of the ith node,
Sᵢₖ is the similarity between the ith and kth nodes
Fₖⱼ is the jth impact factor of the kth node

The RHS of the above equation is summed over the index k, which goes through all the nodes in the cluster.

Before continuing, it should be noted that the examples described above are provided for purposes of illustration, and are not intended to be limiting. Other devices and/or device configurations may be utilized to carry out the operations described herein.

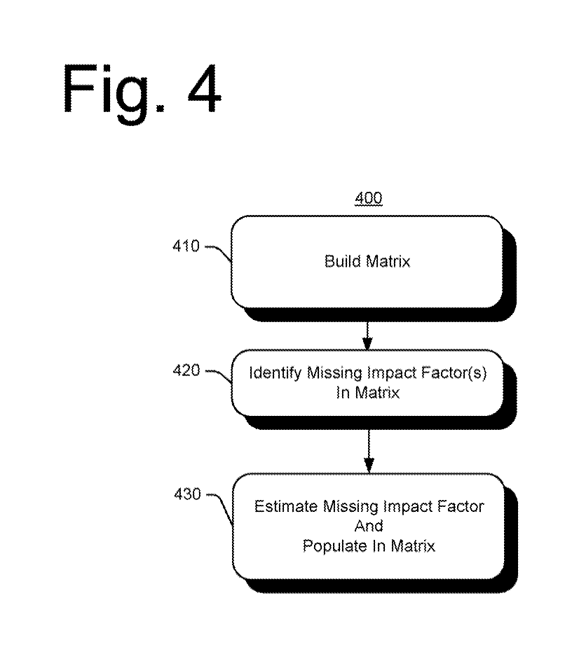

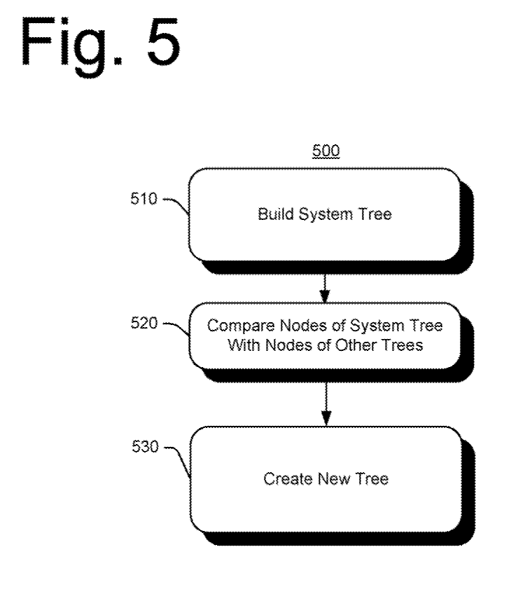

FIGS. 4 and 5 are flowcharts illustrating example operations. Operations 400 in FIG. 4 and 500 in FIG. 5 may be embodied as machine readable instructions on one or more computer-readable medium. When executed on a processor, the instructions cause a general purpose computing device to be programmed as a special-purpose machine that implements the described operations. In an example implementation, the components and connections depicted in the figures may be used.

FIG. 4 is a flowchart illustrating example operations 400 of supplying missing impact factors in a database. In operation 410, a matrix of each tree in the database is provided in computer-readable medium, with each row in the matrix representing a node of the tree, and each column in the matrix representing an impact factor for a component of a system under consideration. In operation 420, at least one missing impact factor is identified in the matrix. In operation 430, the missing impact factor is estimated, and the estimated impact factor is populated in the matrix in the computer-readable medium.

The operations discussed above are provided to illustrate various examples of component substitution for device manufacture. It is noted that the operations are not limited to the ordering shown. Still other operations may also be implemented.

For purposes of illustration, further operations may include clustering nodes with known impact factors, and estimating the missing impact factor based on a metric derived from the clustered nodes. The metric may be a statistical representation of the clustered nodes. In addition, cohesiveness of the clustered nodes may be evaluated so that the clustered nodes include similar impact factor vectors.

Further operations may also include 5 grouping nodes with known impact factors using a k-nearest neighbor approach, and estimating the missing impact factor based on a metric derived from the grouping of nodes. The metric may be a statistical representation of the grouping of nodes.

Further operations may also include grouping nodes with known impact factors using a node similarity metric, and estimating the missing impact factor based on a statistical representation derived from the clustered nodes.

It is also noted that grouping nodes may be based on a combination of clustering, k-nearest neighbor grouping, and/or grouping based on a node similarity metric. In addition, groupings of nodes may be weighted based on similarity before estimating the missing impact factor.

FIG. 5 is a flowchart illustrating example operations 500 of component substitution which may be implemented. In operation 510, building a system tree having a plurality of nodes, each node in the system tree representing a characteristic of a component of the system under consideration. For example, a tree may be for a new laptop computer. The tree may include a motherboard node, a keyboard node, a hard disk drive node, and a display node. The keyboard node may further include a housing node, a cabling/wireless node, and a circuit board node. In this example, the keyboard node is the parent node and the housing node, cabling/wireless node, and circuit board node are child nodes of the keyboard node. Of course, any degree of granularity may be utilized based at least to some extent on design considerations (including desired output, and time to process).

In operation 520, comparing nodes of the tree with nodes in other trees to identify common nodes (or root or similar node). Continuing with the example from operation 510, the tree for the new laptop computer may be compared with trees for other computers, such as other laptop computers, netbook computers, desktop computers, servers, server blades, etc. The common node may be the keyboard node in each of these other trees. Or the common node may be the circuit board child node for the keyboard node or even the motherboard node.

It is noted that, in this example, the tree for the new laptop computer may also be compared with trees for other, at least somewhat unrelated systems. For example, the processor or memory in a mobile phone may be a suitable substitute for the processor or memory in another system, such as a printer.

In operation 530, generating a new tree for the system under consideration by replacing at least one of the common nodes in the system tree with at least one of the nodes in the other trees. For example, the processor from another laptop computer may be substituted for the processor originally chosen for the new laptop computer to give the new laptop computer a lower environmental impact, lower price, higher customer satisfaction, longer warranty, etc. than the initial design for the new laptop computer may have delivered.

It is noted that various of the operations described herein may be automated or partially automated. For example, building system trees may be fully automatic using retrieval routines executed by program code. Alternatively, at least some user interaction may be provided. In such an example, the user may manually provide production specification(s), and then building system trees may be automatic based at least in part of the user-provided product specification(s). The level of user interaction may be any suitable degree. For example, the user may simply identify that the new system is to be an inkjet printer. Alternatively, the user may identify individual components of the inkjet printer, including but not limited to, the type of ink cartridges, processor speed, memory size, paper tray options, and so forth.

In an example, the component substitution operations may be implemented with a customer interface (e.g., web-based product ordering interface). The customer is able to make predetermined selections (e.g., specifying minimum processor speed), and the operations 510-530 described above are implemented on a back-end device to present the user with various designs that meet the customer's minimum expectations. The user can then further select which of the alternatives best suit the customer's preferences (including for price, environmental impact, customer satisfaction, and warranty).

Further operations may also include rating the nodes, wherein replacing the at least one of the nodes in the system tree is based on the rating of the nodes. For example, a processor having a higher energy efficiency rating may receive a higher ranking for environmental impact. A processor that is priced lower may receive a higher ranking for price. A processor that has a higher customer satisfaction may receive a higher ranking for customer satisfaction. The rankings may further be weighted. For example, if the user values a lower environmental impact above price, then the rating for environmental impact is assigned a higher weight than price.

Still further operations may also include populating a database with characteristics of a plurality of components. The characteristics of the components may include price, environmental impact of the components, customer satisfaction, warranty, and other characteristics dependent at least to some extent on design considerations. Some design considerations may include which characteristics are desired by the user, required by regulation, set forth in company policy, and used to meet manufacturing goals, to name only a few examples.

Still further operations may also include identifying structural relationships between the plurality of nodes in the system tree and the nodes in the other trees. For example, structural relationships may include, but are not limited to, parent-child nodes, and parent-grandchildren nodes.

Still further operations may also include determining at least one substitute component for the system under consideration based on the new tree. In an example, further operations may include outputting a bill of materials with the at least one substitute component based on the new tree. The bill of materials may be printed for a user (e.g., a consumer). In an example, the bill of materials may be vetted (e.g., by a design engineer) to ensure that any substitutions are appropriate. For example, a high-efficiency processor for a laptop computer may not be an appropriate substitution for a mobile phone.

It is noted that the examples shown and described are provided for purposes of illustration and are not intended to be limiting. Still other embodiments are also contemplated.

1. A method of supplying missing impact factors in a database, the method carried out by program code stored on non-transient computer-readable medium and executed by a processor, the method comprising:
providing a matrix of each tree in the database in computer-readable medium, with each dimension in the matrix representing a node of the tree, and each other another dimension in the matrix representing an impact factor for a component of a system under consideration;
identifying at least one missing impact factor in the matrix; and
estimating the missing impact factor and populating the estimated impact factor in the matrix in the computer-readable medium.

2. The method of claim 1, further comprising clustering nodes with known impact factors, and estimating the missing impact factor based on a metric derived from the clustered nodes.

3. The method of claim 2, wherein the metric is a statistical representation of the clustered nodes.

4. The method of claim 2, further comprising evaluating cohesiveness of the clustered nodes so that the clustered nodes include similar impact factor vectors.

5. The method of claim 1, further comprising grouping nodes with known impact factors using a k-nearest neighbor approach, and estimating the missing impact factor based on a metric derived from the grouping of nodes.

6. The method of claim 5, wherein the metric is a statistical representation of the grouping of nodes.

7. The method of claim 1, further comprising grouping nodes with known impact factors using a node similarity metric, and estimating the missing impact factor based on a statistical representation derived from the clustered nodes.

8. The method of claim 1, further comprising grouping nodes based on a combination of at least two of clustering, k-nearest neighbor grouping, and grouping based on a node similarity metric.

9. The method of claim 1, further comprising weighting groupings of nodes based on similarity before estimating the missing impact factor.

10. A system for supplying missing impact factors in a database, comprising:
a computer-readable storage to store at least one system tree having a plurality of nodes;
a matrix of each tree in the database stored in the computer-readable storage, each dimension in the matrix representing one of the plurality of nodes of the tree, and each of another dimension in the matrix representing an impact factor for a component of a system under consideration; and
an analysis engine identifying at least one missing impact factor in the matrix, the analysis engine estimating the missing impact factor based on known impact factors, and the analysis engine populating the estimated impact factor in the matrix in the computer-readable medium.

11. The system of claim 10, wherein the analysis engine clusters nodes with known impact factors, and estimates the missing impact factor based on a metric derived from the clustered nodes.

12. The system of claim 11, wherein the metric is a statistical representation of the clustered nodes.

13. The system of claim 11, wherein the analysis engine evaluates cohesiveness of the clustered nodes so that the clustered nodes include similar impact factor vectors.

14. The system of claim 10, wherein the analysis engine groups nodes with known impact factors using a k-nearest neighbor approach, and estimates the missing impact factor based on a metric derived from the grouping of nodes.

15. The method of claim 14, wherein the metric is a statistical representation of the grouping of nodes.

16. The system of claim 10, wherein the analysis engine groups nodes with known impact factors using a node similarity metric; and estimating the missing impact factor based on a statistical representation derived from the clustered nodes.

17. The system of claim 10, wherein the analysis engine groups nodes based on a combination of at least two of clustering, k-nearest neighbor grouping, and grouping based on a node similarity metric.

18. The system of claim 10, wherein the analysis engine weights groupings of nodes based on similarity before estimating the missing impact factor.

19. A system for supplying missing impact factors in a database, comprising:
a matrix of each tree in the database stored in computer-readable storage, each dimension in the matrix representing one of the plurality of nodes of the tree, and each of another dimension in the matrix representing an impact factor for a component of a system under consideration; and
an analysis engine operating to identify at least one missing impact factor in the matrix, the analysis engine operating to estimate the missing impact factor based on known impact factors, and the analysis engine operating to populate the estimated impact factor in the matrix in the computer-readable medium.

20. The system of claim 19, wherein the analysis engine groups nodes based on at least one of clustering, k-nearest neighbor grouping, and grouping based on a node similarity metric.
